(19) United States
(12) Patent Application Publication
(10) Pub. No.: US 2012/0050290 A1
(43) Pub. Date: Mar. 1, 2012

(54) THREE-DIMENSIONAL IMAGE DISPLAY APPARATUS AND DISPLAY METHOD

(75) Inventors: Hitoshi Kobayashi, Kawasaki-Shi (JP); Yoshiyuki Kokojima, Yokohama-Shi (JP); Yuzo Hirayama, Yokohama-Shi (JP); Rieko Fukushima, Tokyo (JP)

(73) Assignee: KABUSHIKI KAISHA TOSHIBA, Tokyo (JP)

(21) Appl. No.: 13/210,965

(22) Filed: Aug. 16, 2011

(30) Foreign Application Priority Data
Aug. 26, 2010 (JP) 2010-189817

(51) Int. Cl. G06T 15/50; G06T 15/00

(52) U.S. Cl. 345/426; 345/419

(57) ABSTRACT

A three-dimensional image display apparatus according to an embodiment includes: a plane display device comprising pixels arranged in a matrix form; an optical plate configured to control light rays illuminated by the plane display device; and a drive circuit including an image processing unit to perform image processing on an input image signal and drive the plane display device based on an image signal processed by the image processing unit. The image processing unit is configured to perform at least one of rearrangement processing for three-dimensional image display on the image signal and filter processing on the image signal.

### CROSS-REFERENCE TO RELATED APPLICATION

This application is based upon and claims the benefit of priority from prior Japanese Patent Application No. 2010-189817 filed on Aug. 26, 2010 in Japan, the entire contents of which are incorporated herein by reference.

### FIELD

Embodiments described herein relate generally to a three-dimensional image display apparatus and a display method.

### BACKGROUND

Typically, in an integral photography (hereafter referred to as “IP”) scheme or a multiview scheme, a display image is generated to cause a perspective projection image to be actually seen at a finite viewing distance. If the pitch of parallax barriers in a horizontal direction is set equal to an integer times the pitch of pixels in the horizontal direction in the IP scheme having only horizontal disparity and having no vertical disparity, a set of parallel rays is generated (hereafter also referred to as “parallel ray one-dimensional IP”). Therefore, a parallax component image obtained by integrating pixel columns which constitute one set of parallel rays is an image which is perspective projection of a certain determinate viewing distance in a vertical direction and orthographic projection in the horizontal direction. A parallax interleaved image is generated by dividing each parallax component image which is orthographic projection in the horizontal direction in every pixel column and combining and disposing resultant images in an interleaved form. By displaying the generated image on the display screen and viewing it through a parallax barrier, a stereoscopic image is obtained. In a multiview scheme, a stereoscopic image of correct projection is obtained by dividing an image obtained by simple perspective projection in every pixel column and combining and disposing resultant images in an interleaved form.

For obtaining orthographic projection data by shooting, a method of converting shooting data of perspective projection to orthographic projection data is realistic, and a light ray space method which is a method using EPI (epipolar plane) and interpolation is known.

A parallel light ray one-dimensional IP scheme has a merit that it is easy to see as compared with a binocular scheme. However, the image format of the parallel light ray one-dimensional IP scheme is complicated. In the binocular scheme and a multiview scheme, the image format is simple and all of respective viewpoint images are generated with the same number of longitudinal and horizontal pixels. In the parallel light ray one-dimensional IP scheme, however, the number of parallax component images is larger, the number of lateral pixels (a horizontal range in use) in respective parallax component images differs according to the parallax direction, and the image format is more complicated, as compared with the multiview scheme which provides nearly the same resolution.

It is necessary to synthesize a parallax interleaved image which is a form of an image displayed on the display screen from two images in the binocular scheme, nine images in a nine-view scheme, or image data divided and recorded in the parallel light ray one-dimensional IP scheme.

Images displayed in such a three-dimensional image display apparatus can be broadly classified into three kinds: (1) a three-dimensional image which displays a parallax interleaved image; (2) a two-dimensional image; and (3) an image obtained by combining a two-dimensional image with a three-dimensional image. As for (3), for example, an image is generated by combining a three-dimensional image of a person with a background of a two-dimensional image, and the resultant image is displayed on the above-described three-dimensional image apparatus. It is possible to strengthen the impression of a three-dimensional image by combining a “two-dimensional image” which looks planar with a “three-dimensional image” which looks stereoscopic and displaying a resultant image.

When displaying a three-dimensional image on a three-dimensional image display apparatus, a parallax interleaved image obtained by combining image data recorded divisionally into an image form displayed on the display screen is used as described above. The “mage data recorded divisionally” used at this time is “different” image data to provide horizontal disparity. Also when displaying a two-dimensional image on a three-dimensional display apparatus, a parallax interleaved image obtained by combining image data recorded divisionally into an image form displayed on the display screen is used in the same way. Since the parallax interleaved image of the two-dimensional image need not provide horizontal disparity, however, all of the “mage data recorded divisionally” are “the same” image data.

As for an example in which a two-dimensional image is displayed in a three-dimensional image display apparatus of the binocular scheme, a method of displaying the same two-dimensional image by using pixels for the right eye and pixels for the left eye jointly is disclosed.

As one of methods for displaying a two-dimensional image on a three-dimensional image display apparatus, there is a method of displaying a two-dimensional image by using a parallax interleaved image. Since a display image is generated considering a parallax barrier included in the display apparatus in this case, the image can be displayed without causing display degradation due to influence of the parallax barrier. Since the “image data recorded divisionally” is used, however, the resolution falls by an amount “being divided.”

### BRIEF DESCRIPTION OF THE DRAWINGS

FIG. 1 is a diagram showing a three-dimensional image display apparatus according to an embodiment of the present invention;

FIGS. 2(a) and 2(b) are perspective views schematically showing a lenticular sheet and a slit plate serving as a parallax barrier;

FIGS. 3(a) to 3(c) are diagrams schematically showing disposition of an optical system in the three-dimensional display image apparatus according to an embodiment and an angle of view on a vertical plane in a viewing space;

FIGS. 4(a) to 4(c) are diagrams for explaining a method for constituting a parallax interleaved image based on a parallax component image in a parallel light ray one-dimensional IP scheme;

FIGS. 5(a) to 5(c) are diagrams for schematically explaining a method for distributing a parallax component image acquired at the time of shooting to a parallax interleaved image;

FIG. 6 is a perspective view schematically showing a configuration of a part of the three-dimensional image display apparatus according to an embodiment;

FIG. 7 is a diagram schematically showing a configuration of the three-dimensional image display apparatus according to an embodiment;

FIG. 8 is a block diagram showing a concrete example of an image processing unit;

FIG. 9 is a flow chart showing a procedure for image processing;

FIG. 10 is a diagram for explaining an interleaved image;

FIG. 11 is a block diagram of a display signal output device and a display signal display device;

FIG. 12 is a schematic diagram showing a relation between display signals and a time axis;

FIG. 13 is a diagram obtained by enlarging a part of a waveform shown in FIG. 12;

FIGS. 14(a) and 14(b) are diagram for explaining filter processing; and

FIG. 15 is a diagram showing assignment of the number of bits required to conduct interleave processing of a two-dimensional image and a three-dimensional image.

### DETAILED DESCRIPTION

A three-dimensional image display apparatus according to an embodiment includes: a plane display device comprising pixels arranged in a matrix form; an optical plate configured to control light rays illuminated by the plane display device; and a drive circuit including an image processing unit to perform image processing on an input image signal and drive the plane display device based on an image signal processed by the image processing unit. The image processing unit is configured to perform at least one of rearrangement processing for three-dimensional image display on the image signal and filter processing on the image signal.

Hereafter, a three-dimensional image display apparatus according to embodiments will be described more specifically with reference to the drawings.

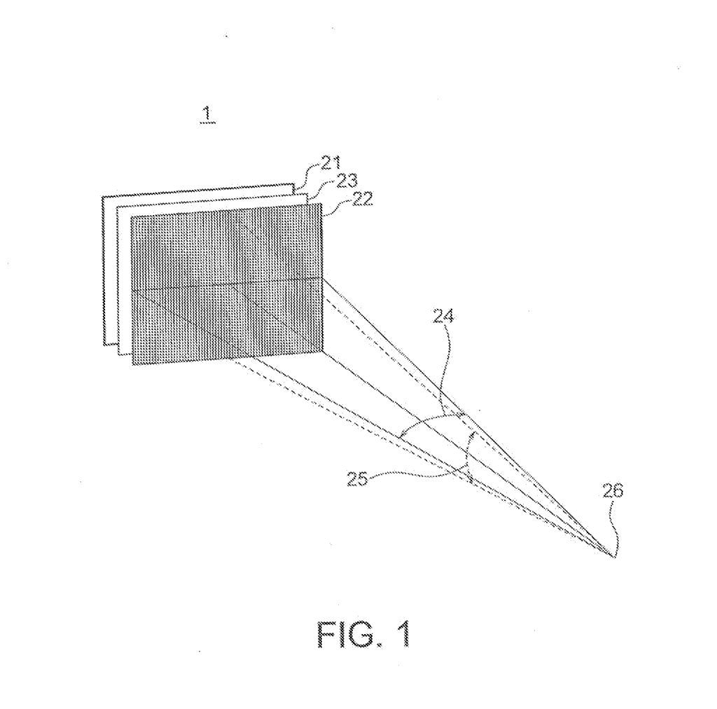

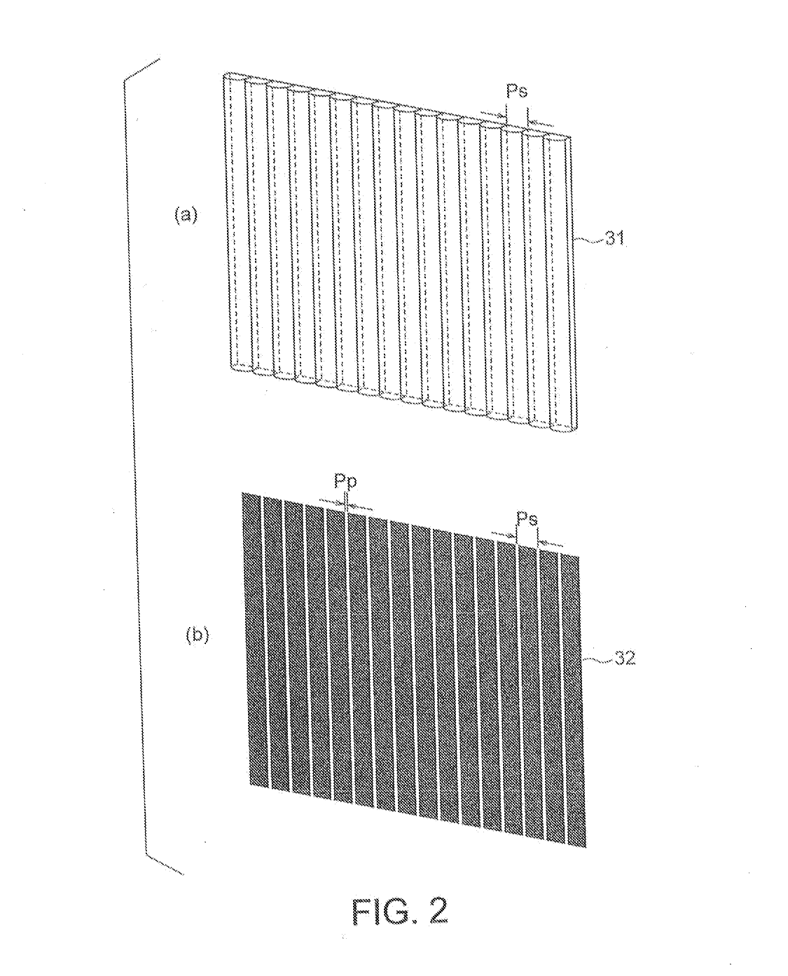

A three-dimensional image display apparatus according to the present embodiment will now be described with reference to FIGS. 1 to 6. FIG. 1 is a perspective view schematically showing the whole of the three-dimensional image display apparatus. A three-dimensional image display apparatus 1 shown in FIG. 1 includes a plane two-dimensional image display device (hereafter also referred to as “plane display device”) 21 which displays a parallax interleaved image serving as a two-dimensional image. An optical plate (also referred to as “parallax barrier”) 22 which controls light rays illuminated from the plane display device 21 is provided in front of the plane display device 21. As the parallax barrier, a lenticular sheet 31 shown in FIG. 2(a) or a slit plate 32 shown in FIG. 2(b) is disposed. The lenticular sheet 31 or the slit plate 32 is generally termed as a parallax barrier 22. The parallax barrier has optical apertures. If the parallax barrier is the lenticular sheet 31, the optical apertures are equivalent to cylindrical lenses. If the parallax barrier is a slit plate 32, the optical apertures are equivalent to slits provided on the slit plate 32. The optical apertures of the parallax barrier 22 substantially restrict light rays illuminated from the plane display device 21 and directed to a viewing zone in which a stereoscopic image is displayed, and the optical apertures of the parallax barrier 22 are provided to correspond to elemental images which constitute a two-dimensional image displayed on the plane display device 21. Therefore, a parallax interleaved image displayed on the plane display device 21 is formed of as many elemental images as the number of optical apertures in the parallax barrier 22. As a result, the elemental images are projected toward the space in the viewing zone respectively via the optical apertures in the parallax barrier 22, and thereby a stereoscopic image is displayed in front of or behind the three-dimensional image display apparatus.

Incidentally, in the three-dimensional image display apparatus 1, a diffusion sheet 23 may be provided between the plane display device 21 and the parallax barrier 22 as occasion demands. Furthermore, the parallax barrier 22 may be installed behind the plane display device 21.

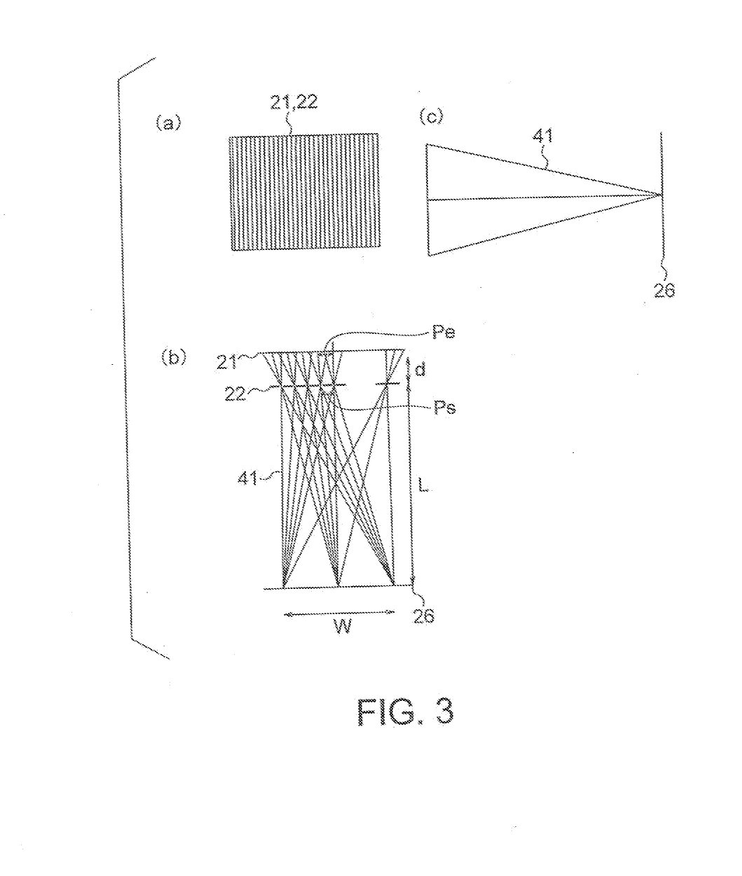

The three-dimensional image display apparatus 1 uses the one-dimensional IP scheme. In the one-dimensional IP scheme, a stereoscopic image which is provided with horizontal disparity but which is not provided with vertical disparity is viewed when seen from a viewpoint 26 located at a supposed viewing distance L. FIG. 3(a) shows a front of the three-dimensional image display apparatus 1. FIG. 3(b) shows arrangement of an optical system in a horizontal plane of the three-dimensional image display apparatus 1 and a light ray group 41 which indicates relations among an elemental image average width Pe, a second horizontal pitch (a horizontal pitch of apertures in the parallax barrier) Ps, a viewing distance L, and a viewing zone width W. FIG. 3(c) schematically shows an angle of view in a vertical plane in a viewing zone space with the plane display device 21 in the three-dimensional image display apparatus 1 shown in FIG. 3(a) taken as reference.

As shown in FIGS. 1 and 3(b), the three-dimensional image display apparatus 1 includes the plane display device 21, such as liquid crystal display elements, which displays a plane image, and a parallax barrier 22 having optical apertures as described above. The parallax barrier 22 is formed of the lenticular sheet 31 or the slit plate 32 taking a shape in which optical apertures extend rectilinearly in the vertical direction and the optical apertures are arranged periodically in the horizontal direction. In a display apparatus of projection type, the parallax barrier 22 is formed of a curved mirror array or the like. In the range of an angle of view 24 in the horizontal direction and an angle of view 25 in the vertical direction in the three-dimensional image display apparatus, the plane display device 21 is viewed from the position of eyes via the parallax barrier 22 and a stereoscopic image can be viewed in front of and behind the plane display device 21. As an example when counted with a pixel group of a minimum unit taking the shape of a square, the number of pixels in the plane display device 21 is 1,400 in the lateral direction (horizontal direction) and 1,050 in the longitudinal direction (vertical direction). It is now supposed that each pixel group of minimum unit includes red (R), green (G) and blue (B) pixels. It should be noted that “pixel” used herein means a minimum unit which can be controlled in luminance independently in one frame of the display screen and red (R), green (G) and blue (B) sub-pixels in the ordinary direct view transmission type liquid crystal panel correspond to the “pixels.”

As shown in FIG. 3(b), if a distance (supposed viewing distance) L between the parallax barrier 22 and the viewing distance plane 26, the parallax barrier pitch (the horizontal pitch of optical apertures in the parallax barrier 22) Ps, and a parallax barrier gap d are determined, the width of each elemental image can be determined. In other words, the elemental image average width Pe is determined by a space between points obtained by projecting aperture centers onto the display plane of the display device along straight lines extended from the viewpoint on the viewing distance plane 26 to centers of apertures (optical apertures of the parallax barrier 22). Reference numeral 41 denotes a line coupling the viewpoint position to each aperture center, and the viewing zone width W is determined from the condition that elemental images should not overlap each other on the display screen of the display device.

As already described, the elemental image corresponds to a two-dimensional interleaved image (a part of a parallax interleaved image) displayed by a set of pixels which generates a light ray flux passed through a certain optical aperture in the parallax barrier 22 and directed toward the viewing zone between the parallax barrier 22 and the viewing distance plane 26. A plurality of elemental images is displayed on the display device 201 and a stereoscopic image is displayed by projecting them.

In a parallel light ray one-dimensional IP scheme in which the horizontal pitch Ps of the apertures is determined to be an integer times a pixel pitch Pp, the average pitch Pe of elemental images which are determined to correspond to respective apertures and which contribute to the display of a stereoscopic image does not become an integer times the pixel pitch Pp, but becomes a value which is equal to the sum of the integer times the pixel pitch Pp and a fraction. Even in a one-dimensional IP scheme in a broad sense in which the horizontal pitch Ps of apertures is not determined to be an integer times the pixel pitch Pp (a parallel light ray group is not formed), in general, the average pitch Pe of the elemental images has a fraction which is a deviation from an integer times the pixel pitch Pp in the same way. On the other hand, in the multiview scheme, the average pitch Pe of the elemental images is determined to be an integer times the pixel pitch Pp. In the one-dimensional IP scheme, an integer obtained when the horizontal pitch Ps of apertures is divided by the pixel pitch Pp is referred to as “number of parallaxes.”

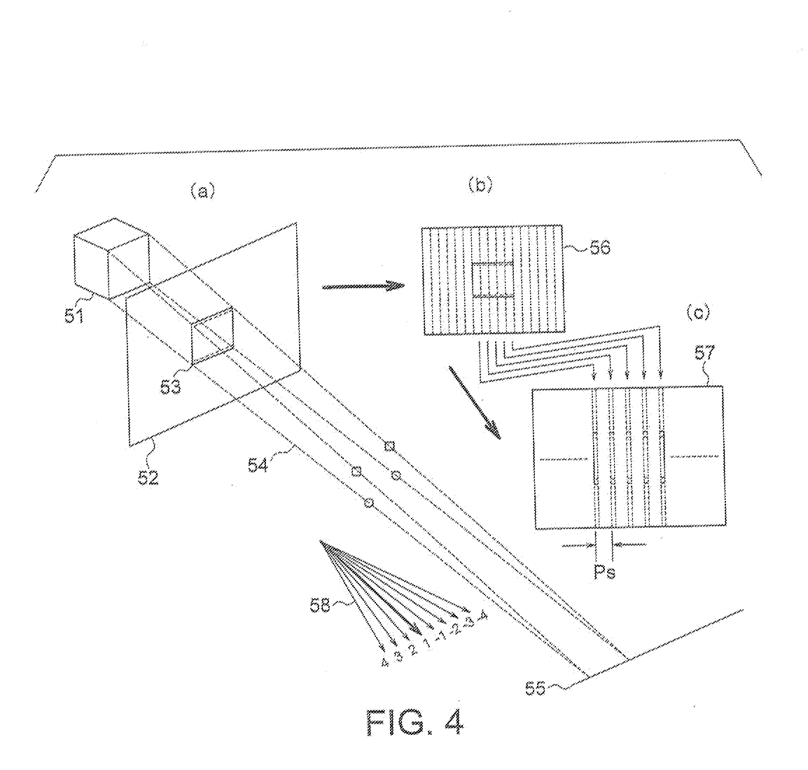

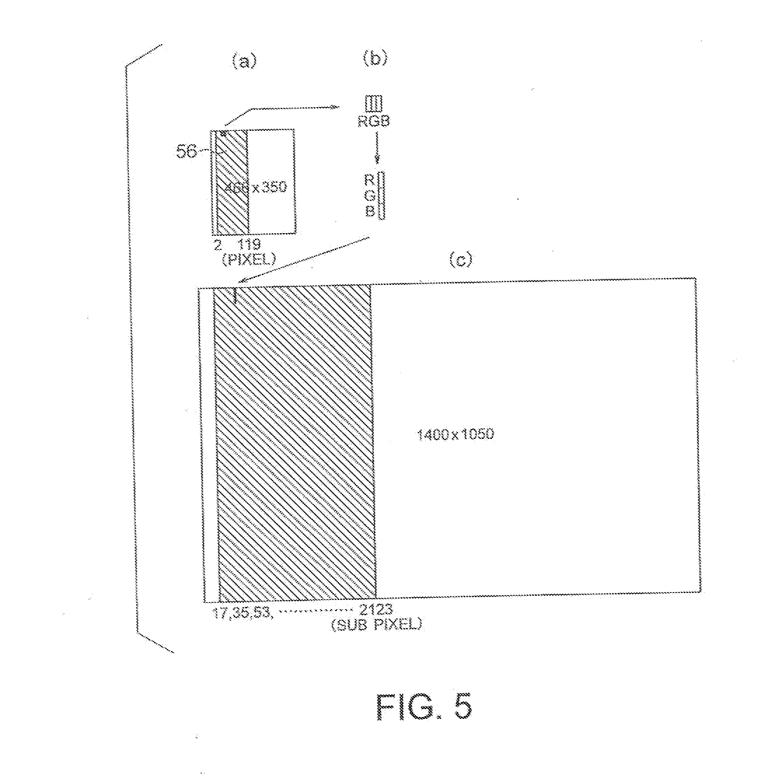

Each elemental image is formed of a set of pixel columns extracted from a parallax component image 56 corresponding to a direction of each parallel light ray group. This will be described with reference to FIGS. 4(a), 4(b), 4(c) and 5. Furthermore, it is apparent that a parallax interleaved image for displaying one stereoscopic image is a set of elemental images (also referred to as “elemental image array”) as well as a set of a large number of parallax component images 56 which constitutes the elemental images (a set synthesized in an interleaved form).

FIGS. 4(a), 4(b), and 4(c) show a method for constituting a parallax interleaved image based on parallax component images in the parallel light ray one-dimensional IP scheme. As shown in FIG. 4(a), an object to be displayed (subject) 51 is projected to a projection plane 52 disposed in a plane where the parallax barrier 22 of the three-dimensional image display apparatus is actually disposed. In the one-dimensional IP, projection is conducted toward a projection line 54 directed to a projection center line 55 determined in a center of a plane which is parallel to the projection plane 52 and which is located at a viewing distance L to implement perspective projection in the vertical direction and orthographic projection in the horizontal direction. In the projection, projection lines do not cross each other in the horizontal direction, but projection lines cross at the projection center line in the vertical direction. According to this projection method, an image 53 of the subject subjected to perspective projection in the vertical direction and orthographic projection in the horizontal direction as shown in FIG. 4(a) is generated on the projection plane 52. The image 53 of the subject shown in FIG. 4(a) corresponds to an image projected in a projection direction 58 denoted by reference numeral 1 in FIG. 4(a). In the one-dimensional IP, the image 53 of the subject projected in a plurality of directions as shown in FIG. 4(a) is needed.

A projection image corresponding to an image in one direction which is perspectively projected in the vertical direction and orthogonally projected in the horizontal direction onto the projection plane 52, i.e., the parallax component image 56, is divided into pixel columns which extend in the vertical direction as shown in FIG. 4(b), distributed to elemental images respectively corresponding to optical apertures, and arranged in a parallax interleaved image 57. The elemental images in the parallax component image 56 are separated from each other and disposed having a space of the aperture pitch Ps (pitch Ps of optical apertures) (sub-pixel column space having the same number as the number of parallaxes) when expressed in a length on the display screen of the plane display device.

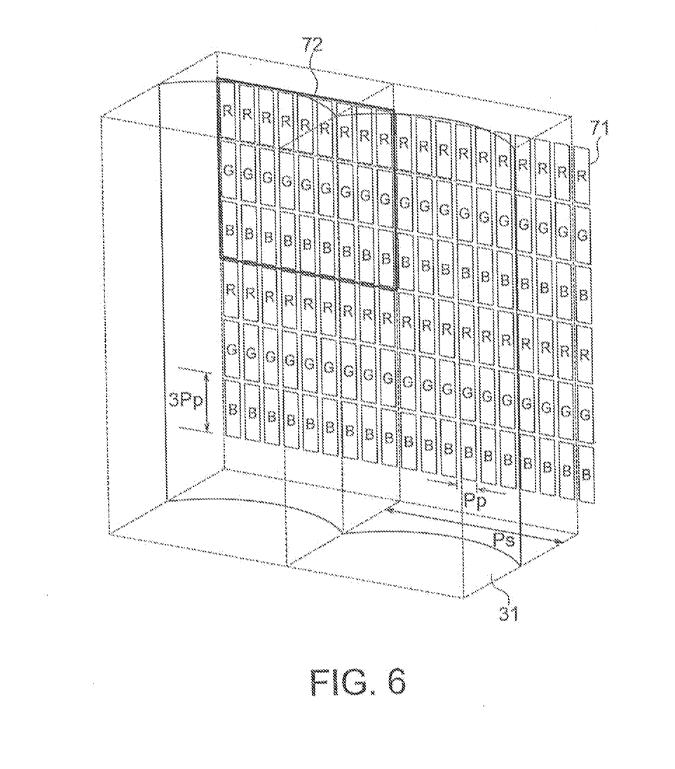

A resolution required for each parallax component image is equal to 1/(the number of parallaxes) of the parallax interleaved image. If the color arrangement on the display plane of the plane display device is mosaic arrangement, it is advantageous to set the horizontal resolution of each parallax component image with respect to the parallax interleaved image equal to 3/(the number of parallaxes) and set the vertical resolution equal to ⅓ (unless the number of parallaxes is 9, however, the aspect ratio of the parallax component image becomes different from unity). FIGS. 5(a), 5(b), and 5(c) show an example in which the number of parallaxes is 9. The number of horizontal pixels in the parallax interleaved image is 4,200 (the number of sub-pixels), whereas the number of horizontal pixels in the parallax component image is 1,400 (the number of sub-pixels) which is one third of 4,200. As shown in FIGS. 5(a) and 5(b), RGB sub-pixels of the parallax component image 56 (camera image) acquired at the time of shooting are arranged in the lateral direction (column direction). However, sub-pixel data from R, G, and B sub-pixels are arranged in the longitudinal direction (column direction) in the parallax interleaved image. For example, R, G and B sub-pixel data are rearranged into sub-pixels which extend in the longitudinal direction (R, G and B sub-pixel data may be rearranged into the order of G, B and R sub-pixel data or B, R and G sub-pixel data which extend in the longitudinal direction) and distributed to pixel columns which extend in the longitudinal direction. Owing to this conversion distribution, the resolution in the horizontal direction in a stereoscopic image display in the one-dimensional IP scheme having only the horizontal parallax can be raised. Horizontal adjacent pixels (an RGB set and an RGB horizontally adjacent thereto) in the parallax component image are separated by as many sub-pixels as the number of parallaxes in the parallax interleaved image and disposed. Such an operation is repeated respectively for other projection directions 58 as well, and the whole of the parallax interleaved image serving as a two-dimensional image displayed on the display screen 57 is completed as shown in FIG. 5(c). As for the projection direction 58, only eight directions −4, −3, −2, −1, 1, 2, 3, and 4 are shown in FIG. 4(a). Depending on the viewing distance, however, several tens directions are needed, and thirteen directions are needed in the example in which the number of parallaxes is nine shown in FIGS. 5(a), 5(b), 5(c) and 6. As for the projected image, i.e., the parallax component image 56, however, 3/(the number of parallaxes) times the number of pixel columns in the parallax interleaved image is the maximum number of pixel columns which can be taken. It suffices that only columns in the required range are generated every projection direction.

The projection directions shown in FIG. 4(a) corresponds parallax directions for viewing the parallax component image 56 specified by a parallax number. The directions are not determined to form equal angles, but the directions are set so as to make spaces between projection centers (camera positions) on the viewing distance plane equal to each other. In other words, spaces between projection centers are set to be equal to each other by translating (with a constant direction) the camera with equal spaces on the projection center line 55 and shooting.

FIG. 6 is a perspective view schematically showing a configuration of a part of the three-dimensional image display apparatus. FIG. 6 shows a case where the lenticular sheet 31 formed of cylindrical lenses extending in the vertical direction and serving as optical apertures is disposed as the parallax barrier 22 in front of the display plane of a planar parallax image display unit such as a liquid crystal panel. The optical apertures of the lenticular sheet 31 are not restricted to the case where the optical apertures extend in the rectilinear form as shown in FIG. 6, but the optical apertures may be disposed and formed obliquely or stepwise. As shown in FIG. 6, pixels 71 having a longitudinal to lateral ratio of 3:1 are arranged in a rectilinear form and a matrix form in the lateral direction and the longitudinal direction on the display plane of the plane display device. The pixels 71 are arranged to have red (R), green (G) and blue (B) pixels on the same row in the lateral direction. This color arrangement is typically called lateral stripe arrangement.

In the display screen shown in FIG. 6, pixels 71 in nine columns by three rows constitute one effective pixel 72. This one effective pixel 72 is indicated by a thick frame in FIG. 6. In such a structure of the display unit, stereoscopic image display which provides nine parallaxes in the horizontal direction is possible.

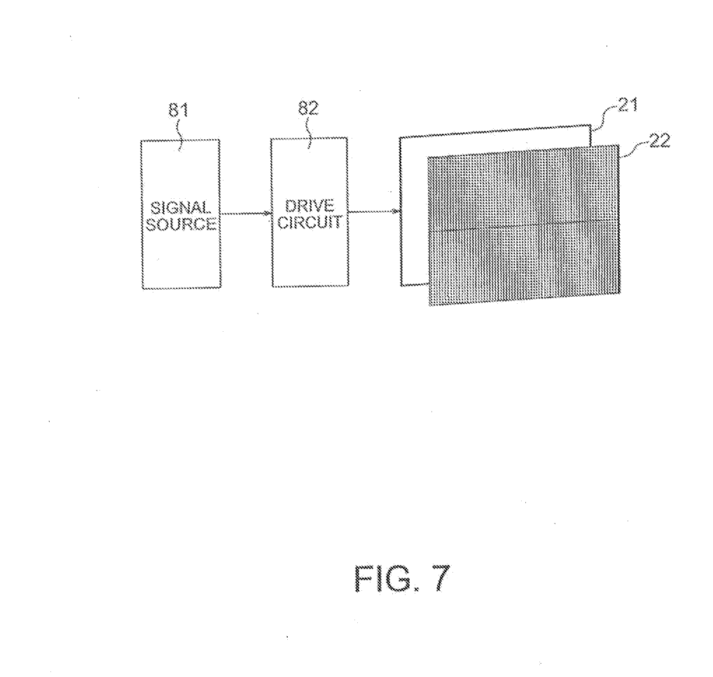

The parallax interleaved image displayed on the plane display device 21 is generated by a drive circuit 82 shown in FIG. 7 and displayed. Image data transmitted to the drive circuit 82 is recorded in a signal source 81 such as a PC (personal computer). The form of data recorded in the signal source 81 is not a parallax interleaved image, but divided image data. The drive circuit 82 not only generates a signal required to drive the plane display device 21, but also conducts rearrangement of divided image data to a parallax interleaved image.

Images displayed in the above-described three-dimensional image display apparatus can be broadly classified into three kinds: a) a three-dimensional image which displays the parallax interleaved image; (2) a two-dimensional image; and (3) an image obtained by combining a two-dimensional image with a three-dimensional image.

When displaying a three-dimensional image, it is necessary to rearrange input images in accordance with a determinate rule. On the other hand, when displaying a two-dimensional image, it is not necessary to conduct this rearrangement. When displaying an interleaved image, processing for interleaving at least two different images is needed. When not displaying an interleaved image, interleave processing is not needed.

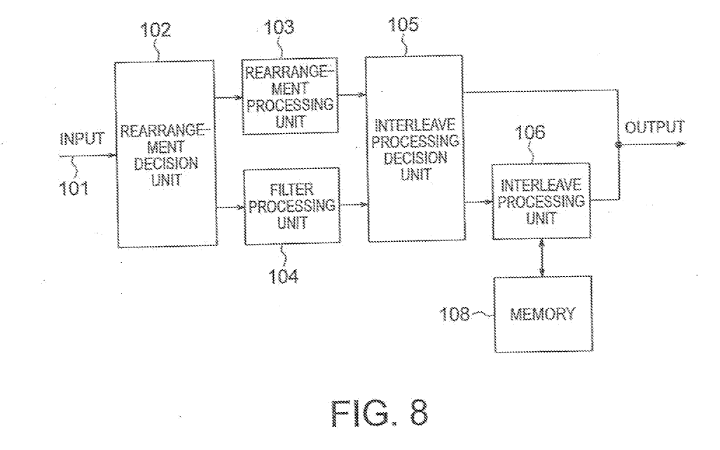

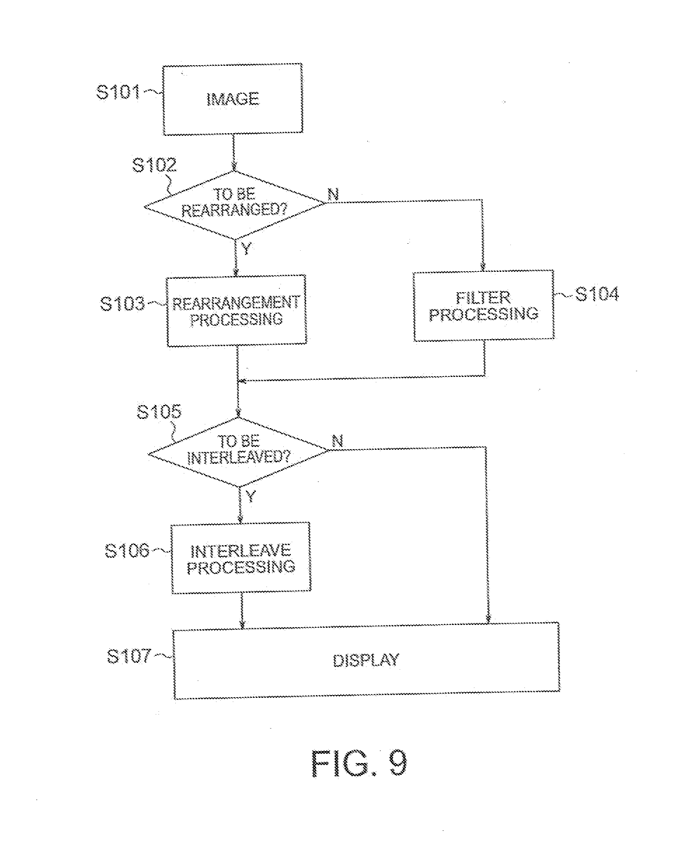

A configuration of an image processing unit in the present embodiment and its processing procedure are shown in FIGS. 8 and 9, respectively. The image processing unit may be incorporated into the drive circuit 82 shown in FIG. 7, or may be provided separately. As shown in FIG. 8, the image processing unit includes a rearrangement decision unit 102, a rearrangement processing unit 103, a filter processing unit 104, an interleave processing decision unit 105, an interleave processing unit 106, and a memory 108.

The processing procedure will now be described. As shown in FIG. 9, an image signal is first input (S101). Then, the rearrangement decision unit 102 makes a decision whether rearrangement processing is necessary for the image signal 101 which has been input (S102). In the case where the rearrangement is necessary (mainly in the case of a three-dimensional image), the image signal is transmitted to the rearrangement processing unit 103 and rearrangement processing is performed therein (S103). In the case where the rearrangement is not necessary (mainly in the case of a two-dimensional image), the image signal is transmitted to the filter processing unit 104 and filter processing is performed (S104). The image subjected to the rearrangement processing or the image subjected to the filter processing is input to the interleave processing decision unit 105. The interleave processing decision unit 105 makes a decision whether interleaving is necessary (S105). If the interleaving is necessary, the image signal is transmitted to the interleave processing unit 106 and subject to interleave processing (S106). The interleave processing unit 106 conducts processing of interleaving an object of a three-dimensional image with a background of a two-dimensional image and displaying a result. This processing is used to obtain a display effect of “an object moving on a changeless background” or “causing an object to be projected.” And the interleaved image signal is transmitted from the interleave processing unit 106 to the plane display device 21 and displayed (S107). If the interleave processing is unnecessary, the image signal is sent to the plane display device as it is. Incidentally, in the present embodiment, the memory 108 is used to perform the interleave processing. This is because images to be interleaved are transmitted one after another and consequently the images need to be retained in the image memory 108 temporarily.

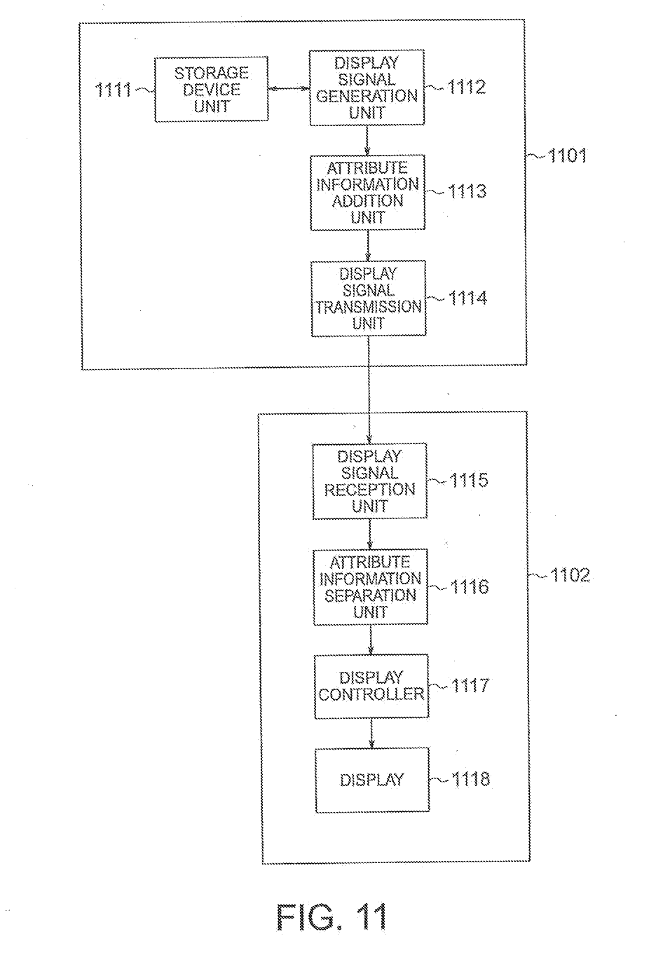

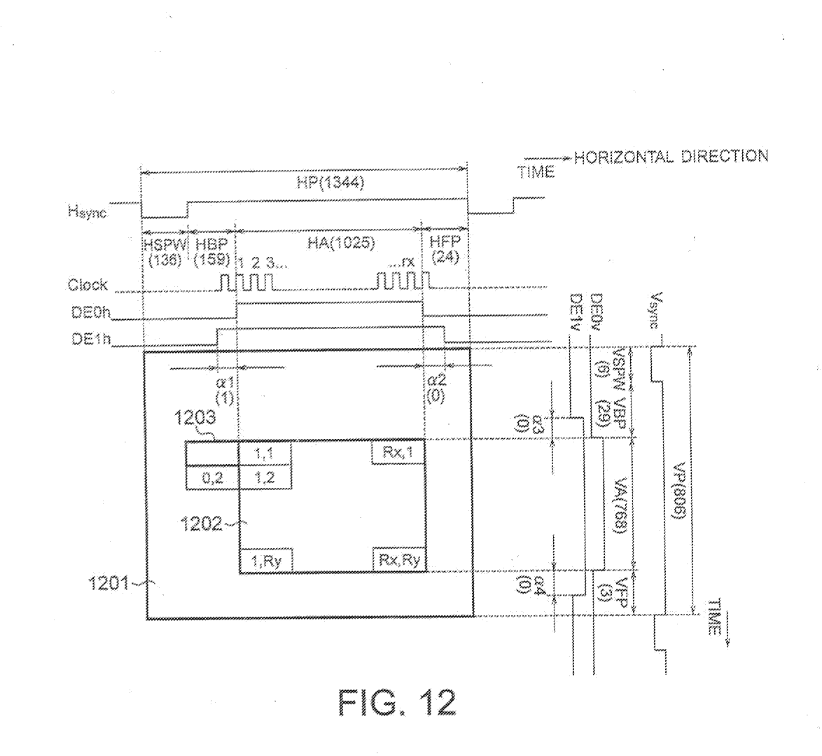

The rearrangement processing decision unit 102 and the interleave processing decision unit 105 make a decision on what kind of processing should be performed on an image signal which has been input, on the basis of attribute information given to the image signal 101. The attribute information is added before (a1) or after (a2) a term of validity (first term) in the horizontal direction of a data enable (DE) signal, before (a3) and after (a4) a term of validity (second term) in the vertical direction of the data enable (DE) signal, or before and after the image signal. This process will now be described with reference to FIGS. 11 and 12.

FIG. 11 is a diagram showing a display signal output device 1101 and a display signal display device 1102. In FIG. 11, each of data flows between blocks in the display signal output device 1101 and the display signal display device 1102 is represented by an arrow. The display signal output device 1101 and the display signal display device 1102 correspond to the signal source 81 and the drive circuit 82 shown in FIG. 7, respectively.

The display signal output device 1101 includes a storage device unit 1111, a display signal generation unit 1112, an attribute information addition unit 1113, and a display signal transmission unit 1114. The display signal display device 1102 includes a display signal reception unit 1115, an attribute information separation unit 1116, a display controller 1117, and a display 1118.

The storage device unit 1111 stores image data which serves as a source of an image to be displayed on the display 1118. The image data from a broadcast wave, a storage disk which stores image contents, or a computer network is input to the storage device unit 1111. In some cases, image data which is input to the storage device unit 1111 is the whole of image data. In other cases, the whole of image data such as image data which has been input from, for example, a broadcast wave or a computer network is input in time series, and a part of the image data is stored in the storage device unit 1111.

The display signal generation unit 1112 includes an image signal generation unit which generates an image signal of every frame on the basis of image data stored in the storage device unit 1111, a clock signal generation unit which generates a clock signal (Clock), a data enable generation unit which generates a data enable signal (DE0), a vertical synchronization signal generation unit which generates a vertical synchronizing signal (Vsync), and a horizontal synchronization signal generation unit which generates a horizontal synchronization signal (Hsync).

The attribute information addition unit 1113 adds attribute information to the signal generated by the display signal generation unit 1112.

The display signal transmission unit 1114 converts display signals which have been generated by the display signal generation unit 1112 and the attribute information addition unit 1113 to an image signal, and transmits the image signal to the display signal display device 1102.

The display signal reception unit 1115 receives the image signal transmitted by the display signal transmission unit 1114 and converts the image signal to display signals.

The attribute information separation unit 1116 discriminates and separates the attribute information added by the attribute information addition unit 1113, and transmits the display signals to the display controller 1117.

The display controller 1117 controls the display 1118 on the basis of the received image signal, synchronization signal, clock signal, DE signal, and attribute information.

FIG. 12 is a diagram schematically showing the Clock signal, the DE signal (DE0 and DE1), the Vsync signal, and the Hsync signal from among display signals generated at display plane coordinates of the display 1118 by the display signal generation unit 1112.

The clock signal constantly assumes an H term and an L term repeatedly. All display signals such as the DE signal (DE0 and DE1), the Vsync signal, and the Hsync signal are synchronized to the clock signal. In an example shown in FIG. 12, the display signals are synchronized to a rising edge of the Clock signal.

The DE0 signal is a signal which prescribes a valid term and an invalid term of the image signal. For example, the DE0 signal assumes a valid term during a term (H term) of a high level (a first data enable signal level) and assumes an invalid term during a term (L term) of a low level (a second data enable signal level). In FIG. 12, the DE0 signal is separated into a horizontal term (DE0h) and a vertical term (DE0v) and schematically shown for convenience of description. However, the DE0 signal is a single DE signal having the horizontal term and the vertical term. The DE0h signal schematically showing the DE signal during the horizontal term assumes a valid display term during the H term and assumes an invalid display term during the L term in the same way as the DE signal. The DE0v signal schematically showing the DE signal during the vertical term assumes a valid display term during the H term and assumes an invalid display term during the L term in the same way as the DE signal.

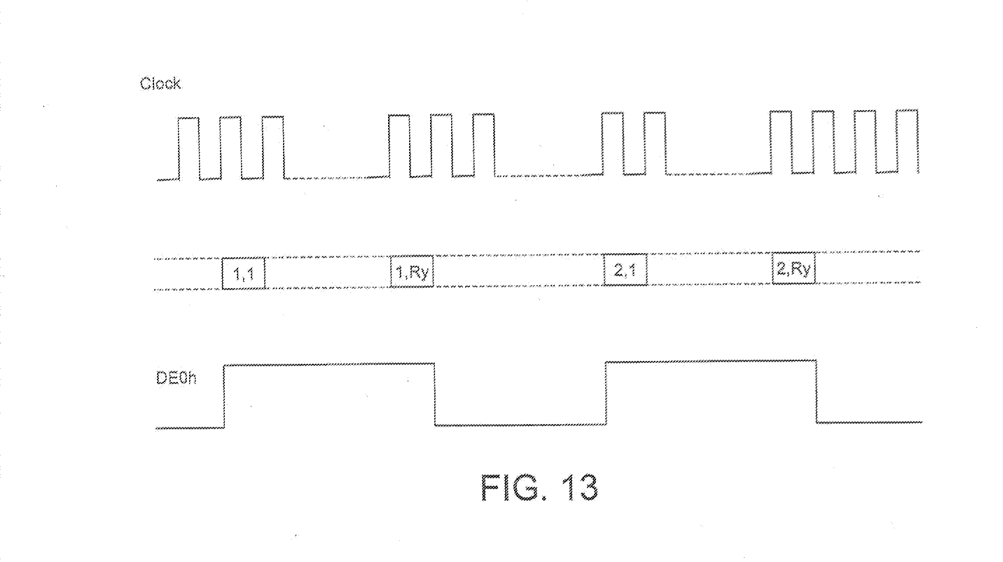

The DE0 signal assumes an H term and an L term repeatedly in synchronism with the Clock signal. FIG. 13 shows an example obtained by enlarging a part of FIG. 12. In this example, the DE0 signal repeatedly assumes an H term between a Clock signal corresponding to a screen coordinate (1, 1) and a clock signal corresponding to a screen coordinate (Rx, 1); an L term between a Clock signal immediately subsequent to that corresponding to the screen coordinate (Rx, 1) and a clock signal immediately preceding that corresponding to a screen coordinate (1, 2); and an H term between the clock signal corresponding to the screen coordinate (1, 2) and a clock signal corresponding to a screen coordinate (Rx, 2). Between start of the H term corresponding to the screen coordinate (1, 1) and end of the H term corresponding to a screen coordinate (Rx, Ry), the H term corresponds to HA multiplied by VA in terms of the number of clocks.

The Vsync signal has an L term and an H term. The L term has a vertical sync pulse term (also referred to as “VSPW term”). The H term includes a vertical back porch term (hereafter also referred to as “VBP term”) between end of the L term of the VSPW term and start of a valid term, a valid display term (VA), and a vertical front porch term (VFP) between end of the valid display term (VA) and start of the next VSPW term.

The Hsync signal has an L term and an H term. The L term has a horizontal sync pulse term (hereafter also referred to as “HSPW term”). The H term includes a horizontal back porch term (HBP) between end of the L term of the HSPW term and start of a valid term, a valid display term (HA), and a horizontal front porch term (HFP) between end of the HA term and start of the next HSPW term.

Additional terms a1, a2, a3, and a4 are terms for adding or transmitting the attribute information. The additional term a1 is a term immediately preceding the valid term of the DE0h signal, and the additional term a2 is a term immediately succeeding the valid term of the DE0h signal. The additional term a3 is a term obtained by adding the additional terms a1 and a2 to the HA term in an interval immediately preceding the screen coordinate (1, 1). The additional term a4 is a term obtained by adding the additional terms a1 and a2 to the HA term in an interval immediately succeeding the screen coordinate (Rx, Ry). Each of the additional term a3 and the additional term a4 need not be always a continuous term, but may extend over a term obtained by adding the additional term a1 and the additional term a2 to a plurality of consecutive HA terms. The additional terms a1, a2, a3, and a4 can be set in the following ranges according to the quantity of the attribute information.
a1: 0≦a1≦HBP
a2: 0≦a2≦HFP
a3: 0≦a3≦VBP
a4: 0≦a4≦VFP
   For example, the user can arbitrarily set arbitrary information having a maximum number represented by:

{(a1+HA+a2)×(a3+VA+a4)−(HA×VA)}×(the number of gradations (bits)

In this method, for example, information representing whether to conduct the rearrangement processing should be set in the highest order bit (for example, “1” should be set when conducting the rearrangement and “0” should be set when not conducting the rearrangement), and information representing whether to conduct the interleave processing should be set in the next bit (for example, “1” should be set when conducting the interleaving and “0” should be set when not conducting the interleaving).

The image signal 1201 has, for example, each 6 bit or 8 bit data for red, blue, and green. When the DE0 signal is in the H term, the image signal 1201 is handled as a valid image signal 1202 and displayed on the display 1118. On the other hand, when the DE0 signal is in the L term, the image signal 1201 is handled as an invalid image signal and is not displayed on the display 1118.

The image signal 1201 further has attribute information. When the DE0 signal is in the L term and the DE1 signal is in the H term, the image signal 1201 is handled as valid attribute information 1203. The display signals with the attribute information added by the attribute information addition unit 1113 are transmitted from the display signal transmission unit 1114 and received by the display signal reception unit 1115. The attribute information 1203 is separated by the attribute information separation unit 1116, and the valid image signal 1202 is transmitted to the display controller 1117 and an image is displayed on the display 1118.

When displaying a three-dimensional image in the three-dimensional image display apparatus according to the present embodiment, the processing for generating a parallax interleaved image from divided image data is necessary as described above. Concrete generation processing is well known and described in, for example, Japanese Patent No. 4202991. Furthermore, in the three-dimensional image display apparatus according to the present embodiment, the filter processing described with reference to FIG. 9 is processing for displaying a two-dimensional image with reduced degradation.

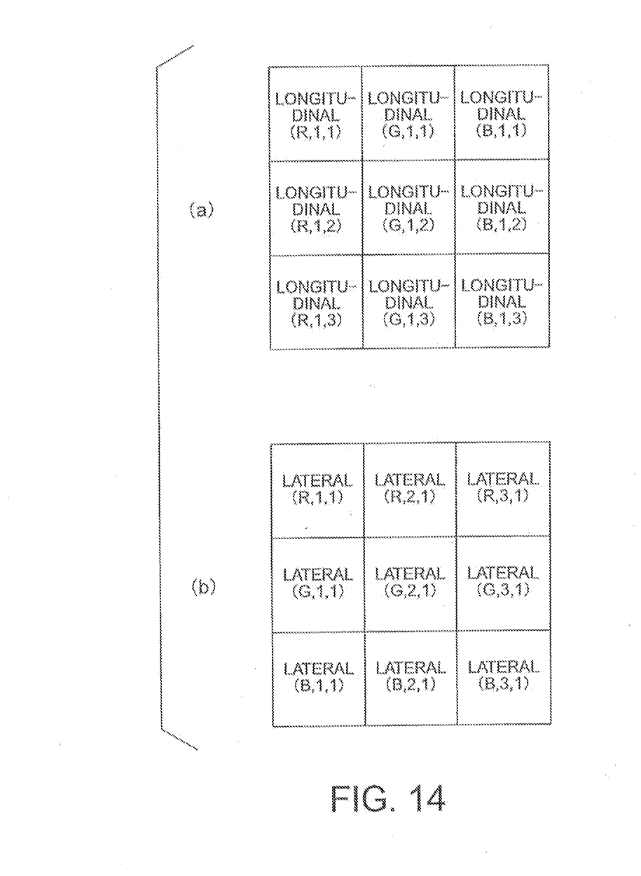

The filter processing will now be described with reference to FIGS. 14(a) and 14(b). The filter processing is processing for displaying an image generated for longitudinal stripe arrangement shown in FIG. 14(a) with an image display of lateral stripe arrangement shown in FIG. 14(b). In the image display of longitudinal stripe arrangement and the image display of lateral stripe arrangement which are equivalent in the total number of pixels, the longitudinal to lateral ratio differs. For example, an image display apparatus of ordinary longitudinal stripe arrangement having lateral 1,400 pixels (4,200 sub-pixels) by longitudinal 1,050 pixels is equivalent to an image display apparatus of lateral stripe arrangement having lateral 4,200 pixels by longitudinal 350 pixels (1,050 sub-pixels).

FIG. 14(a) shows longitudinal stripe arrangement having three sub-pixels and three columns in the longitudinal direction. “Longitudinal (R, 1, 1)” in FIG. 14(a) represents “longitudinal arrangement, red color, first pixel, and first column.” In the same way, “longitudinal (G, 1, 1) represents “longitudinal arrangement, green color, first pixel, and first column,” and “longitudinal (B, 1, 1) represents “longitudinal arrangement, blue color, first pixel, and first column.” FIG. 14(b) shows lateral stripe arrangement having three pixels in the lateral direction and three sub-columns in the longitudinal direction. “Lateral (R, 1, 1)” in FIG. 14(b) represents “lateral arrangement, red color, first pixel, and first column.” In the same way, “lateral (G, 1, 1) represents “lateral arrangement, green color, first pixel, and first column,” and “lateral (B, 1, 1) represents “lateral arrangement, blue color, first pixel, and first column.”

(Three-sub-pixels, three columns) in FIG. 14(a) is associated with (three pixels, three sub-columns) in FIG. 14(b). As for a specific processing method, an average value of luminance corresponding to three sub-pixels, i.e. “longitudinal (R, 1, 1),” “longitudinal (R, 1, 2)” and “longitudinal (R, 1, 3),” is assigned to “lateral (R, 1, 1),” “lateral (R, 2, 1)” and “lateral (R, 3, 1).” As a result, the “lateral (R, 1, 1),” “lateral (R, 2, 1)” and “lateral (R, 3, 1)” have the same luminance. In the same way, an average value of luminance corresponding to three sub-pixels, i.e. “longitudinal (G, 1, 1),” “longitudinal (G, 1, 2)” and “longitudinal (G, 1, 3),” is assigned to “lateral (G, 1, 1),” “lateral (G, 2, 1)” and “lateral (G, 3, 1).” An average value of luminance corresponding to three sub-pixels, i.e. “longitudinal (B, 1, 1),” “longitudinal (B, 1, 2)” and “longitudinal (B, 1, 3),” is assigned to “lateral (B, 1, 1),” “lateral (B, 2, 1)” and “lateral (B, 3, 1).” By conducting processing described heretofore, an image generated for the longitudinal stripe image display apparatus can be displayed on a lateral stripe image display apparatus without having much degradation.

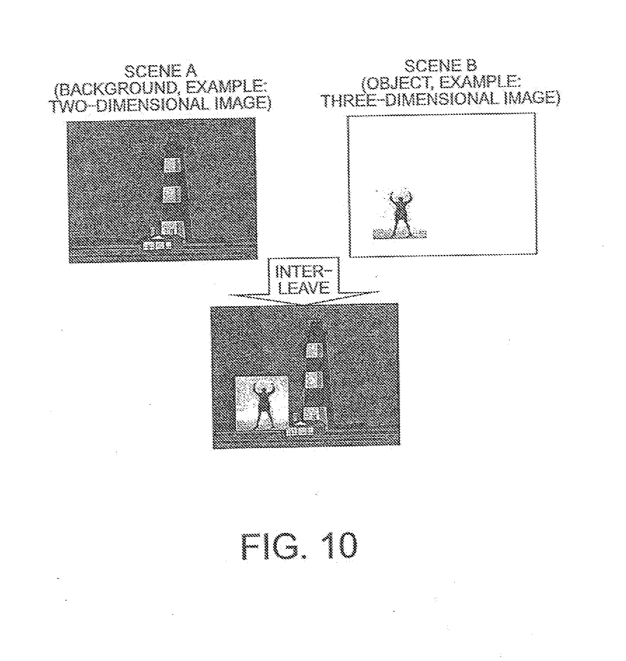

Interleave processing of a two-dimensional image and a three-dimensional image shown in FIG. 10 will now be described. In this example, the size of a displayed image is lateral 1,400 pixels (4,200 sub-pixels) by longitudinal 1,050 pixels. However, the scope of the present invention is not restricted thereto. First, as for a two-dimensional image used as a background, an image having lateral 1,400 pixels (4,200 sub-pixels) by longitudinal 1,050 pixels subjected to filter processing is prepared. Then, as for a three-dimensional image to be stuck to the two-dimensional image, an image having an arbitrary size subjected to the rearrangement processing is prepared. In this example, the size is set to lateral 150 pixels by longitudinal 150 pixels (450 sub-pixels). If the attribute information shown in FIG. 12 is provided with a start position of sticking the three-dimensional image (for example, lateral 100 pixels (300 sub-pixels) and longitudinal 500 pixels) and the size of the three-dimensional image, interleave processing of the two-dimensional image and the three-dimensional image is conducted on the basis of the start position.

The position in which the three-dimensional image is stuck is one of 4,200 pixels including sub-pixels in the lateral direction. As for the longitudinal direction, the position is 350 pixels because (R, G, and B) is the unit. Therefore, 13 bits are needed to prescribe the lateral direction and 9 bits are needed to prescribe the longitudinal direction. In the same way, 13 bits are needed in the lateral direction and 9 bits are needed in the longitudinal direction to prescribe the size of the three-dimensional image as well. One bit is needed to distinguish the two-dimensional image from the three-dimensional image. One bit is needed to make a decision whether to conduct interleave processing. Twenty-two bits are needed to prescribe the start position in which the three-dimensional image is stuck. Twenty-two bits are needed to prescribe the size of the three-dimensional image. Therefore, 46 bits in total are needed. In an interface of DVI (Digital Visual Interface) standards determined by the DDWG (Digital Display Working Group), eight bits are assigned to each of R, G, and B colors.

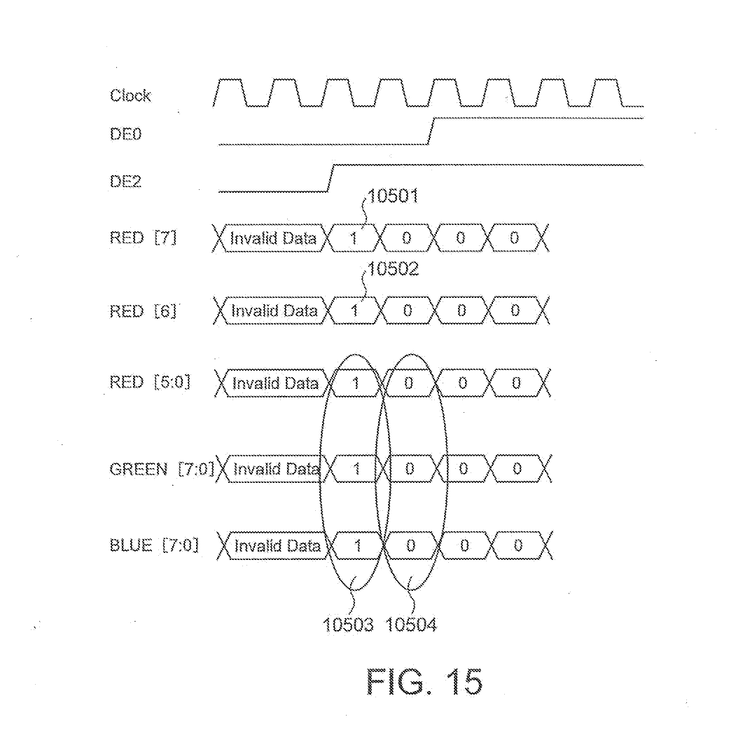

FIG. 15 shows an example of assignment of 46 bits. A DE2 signal is generated by expanding, by two clocks, the horizontal term of the DE0 signal which is a signal prescribing the valid term and the invalid term of an image signal (R, G and B). Forty-six bits are assigned to the expanded image signal (R, G and B) corresponding to two clocks. A discrimination signal 10501 of the two-dimensional image and the three-dimensional image is assigned to seven bits of R preceding the DE0 by two clocks, and a discrimination signal 10502 of interleave processing is assigned to six bits of R preceding the DE0 by two clocks. In addition, 22 bits in total are assigned to a sticking start position 10503. The 22 bits are the sum total of six bits ranging from a zeroth bit to a fifth bit of R preceding DE0 by two clocks, eight bits ranging from a zeroth bit to a seventh bit of G preceding DE0 by two clocks, and eight bits ranging from a zeroth bit to a seventh bit of B preceding DE0 by two clocks. Another 22 bits in total are assigned to a size 10504 of the three-dimensional image. The 22 bits are the sum total of six bits ranging from a zeroth bit to a fifth bit of R preceding DE0 by one clock, eight bits ranging from a zeroth bit to a seventh bit of G preceding DE0 by one clock, and eight bits ranging from a zeroth bit to a seventh bit of B preceding DE0 by one clock.

According to the present embodiment, a parallax interleaved image is not generated when displaying a two-dimensional image as described heretofore. As a result, the degradation of the resolution can be suppressed and image generation can be conducted at high speed.

While certain embodiments have been described, these embodiments have been presented by way of example only, and are not intended to limit the scope of the inventions. Indeed, the novel methods and systems described herein can be embodied in a variety of other forms; furthermore, various omissions, substitutions and changes in the form of the methods and systems described herein can be made without departing from the spirit of the inventions. The accompanying claims and their equivalents are intended to cover such forms or modifications as would fall within the scope and spirit of the inventions.

What is claimed is:

1. A three-dimensional image display apparatus comprising:
a plane display device comprising pixels arranged in a matrix form;
an optical plate configured to control light rays illuminated by the plane display device; and
a drive circuit including an image processing unit to perform image processing on an input image signal and drive the plane display device based on an image signal processed by the image processing unit,
the image processing unit configured to perform at least one of rearrangement processing for three-dimensional image display on the image signal and filter processing on the image signal.

2. The apparatus according to claim 1, wherein the image processing unit performs processing for averaging luminance of a plurality of pixels having same color information and assigning the averaged luminance to a plurality of pixels as the filter processing.

3. The apparatus according to claim 1, wherein the image processing unit performs processing for interleaving an image signal subjected to the rearrangement processing and an image signal subjected to the filter processing, and thereby generating one interleaved image signal.

4. The apparatus according to claim 3, wherein the image processing unit selects one out of the image signal subjected to the rearrangement processing, the image signal subject to the filter processing, and the interleaved image signal, and sends the selected one signal to the plane display device.

5. A display method for three-dimensional image display apparatus comprising a plane display device including pixels arranged in a matrix form and an optical plate configured to control light rays illuminated by the plane display device, the display method comprising:
performing at least one processing out of rearrangement processing for three-dimensional image display on the image signal and filter processing on the image signal, based on an attribute signal added to the image signal; and
driving the plane display device based on the image signal processed by the at least one processing.
